(19) United States
(12) Patent Application Publication
(10) Pub. No.: US 2008/0136301 A1
(43) Pub. Date: Jun. 12, 2008

(54) Tool and utensil stowage system

(76) Inventors: Randall J. Harbison, Austin, TX (US); Douglas E. Clancy, Austin, TX (US)

Correspondence Address: Christopher J. Whewell;Western Patent Group, 6020 Tonkowa Trail, Georgetown, TX, 78628, US

(21) Appl. No.: 12/069,463

(22) Filed: Feb. 11, 2008

Related U.S. Application Data
(63) Continuation-in-part of application No. 11/786,979, filed on Apr. 13, 2007.
(60) Provisional application No. 60/794,387, filed on Apr. 24, 2006.

(51) Int. Cl. A47B 77/14; A47J 47/16

(52) U.S. Cl. 312/334.1; 248/37.3; 211/134

(57) ABSTRACT

Provided are combinations useful for stowage and retrieval of various wares and utensils. A combination according to the disclosure is especially well-suited for use within a cabinet, such as within a kitchen environment. The disclosure provides a slidable support base upon the top surface of which a plurality of retaining portions may be readily disposed, to create spaces within which a ware or utensil may be rigidly located. The slidable support base may be pulled out to gain access to the wares stored on the platform. A combination according to the disclosure makes efficient use of cabinet space with respect to prior art stowage means, and provides for the wares to be disposed in such fashion that their retrieval is prompt and convenient.

### CROSS-REFERENCE TO RELATED APPLICATIONS

This application claims the benefit of U.S. Provisional Application No. 60/794,387 filed Apr. 24, 2006, and is a Continuation-In-Part of U.S. patent application Ser. No. 11/786,979 filed Apr. 13, 2007, currently still pending, the entire contents of both of which are herein fully incorporated by reference.

### TECHNICAL FIELD

This disclosure relates generally to storage means for utensils. More particularly, it relates to systems and devices used in the storage of tools, utensils, and wares used in a household or kitchen setting, including pots, pans, and other implements.

### BACKGROUND

Various storage means for conveniently storing a variety of implements, utensils, and wares have been contrived over the years. The products of the labors of a few workers in the prior art are embodied in several U.S. patent documents, including: U.S. Pat. Nos. 4,296,984; 5,000,326; 5,094,352; 5,474,374; 5,676,262; 5,765,700; 5,813,736; 6,131,746; 6,227,387; and 6,293,414.

Of the storage means of the prior art, none are without strong limitations and drawbacks. This is especially true in the case of when it is desired to store pots and pans. Typically, in the average domestic kitchen, pots and pans are placed in a drawer or cabinet. Since pans frequently have handles attached to them, the handles of several pans stored in the same space interfere with the efficiency of the storage of all of the pans, severely restricting the number of pans which may be stored in a given drawer or cabinet. U.S. Pat. No. 6,769,751 provided a storage shelf upon which various wares which may be commonly stowed during times of their non-use, including kitchen utensils such as pots, pans, and other wares having handles intended to be grasped by their user, comprising a sliding storage assembly which stores such wares with their handles in a stowed position, until the storage shelf of the disclosure is moved laterally, such as pulling towards the user, at which time the handles of the wares are automatically caused to be tilted upwards towards the user for ready grasping and added convenience. However, the disclosure of U.S. Pat. No. 6,769,751 contained many moving parts, which adds to the cost of manufacturing the devices described therein. What is needed is a more simplistic (and lower cost) method of accomplishing the desired result of efficient use of space in storage of kitchen utensils and other wares. Of all the devices in the prior art, none comprises a slidable platform which enables the compact storage of bulky utensils that comprise a handle means as a portion of their construction, while simultaneously providing easy access in retrieval of such utensils when desired. The present disclosure provides such a storage means, and is of simplistic construction and high utility and user-friendliness, as this specification now demonstrates.

### SUMMARY OF THE DISCLOSURE

The present disclosure provides a device useful for the convenient storage and retrieval of various wares and utensils. A device of the disclosure comprises a substantially-planar support base having a top surface, a front edge portion and a rear edge portion, with the top surface further including a plurality of holes disposed therethrough. There is also a frame means or portion, and a means for slidably connecting the support base to the frame construct, sufficient to enable lateral movement of the support portion with respect to the frame construct. There is also a plurality of support forms attached to the top surface of the slidable portion. The support forms each comprise a retaining portion portion and an end portions portion, wherein the end portions portions are adapted to be received by the holes disposed on the support portion.

### BRIEF DESCRIPTION OF THE DRAWINGS

FIG. 1A shows a perspective view of a planar support base according to one embodiment of the disclosure;

FIG. 1B shows an overhead view of a support portion useful in providing a combination according to one embodiment of the disclosure;

FIG. 1C shows a sectional view of a support portion useful in providing a combination according to one embodiment of the disclosure;

FIG. 1D shows a perspective view of a planar support base according to an alternate embodiment of the disclosure;

FIG. 2 shows a perspective view of a planar support base having an attached means for slidably connecting said support base to a frame, according to one embodiment of the disclosure;

FIG. 3 shows a frame construct having an attached means for slidably connecting said support base to said frame, according to one embodiment of the disclosure;

FIG. 4 shows a planar support base in one of its possible positions when attached to a frame construct according to one embodiment of the disclosure;

FIG. 5A shows a configuration of a support form according to one embodiment of the disclosure;

FIG. 5B shows a configuration of a support form according to one embodiment of the disclosure;

FIG. 5C shows a configuration of a support form according to one embodiment of the disclosure;

FIG. 5D shows configurations of a support form according to different embodiments of the disclosure;

FIG. 5E shows a configuration of a support form according to one embodiment of the disclosure;

FIG. 5F shows a section view of a support form in place in a support portion according to one embodiment of the disclosure;

FIG. 6 shows a planar support base in one of its possible positions when attached to a frame construct according to one embodiment of the disclosure, and further including a plurality of support forms attached to the support base;

FIG. 7 shows the use of a planar support base according to one embodiment of the disclosure, for securing a kitchen implement;

FIG. 8 shows a perspective view of a plurality of support forms disposed on a support base according to one embodiment of the disclosure;

FIG. 9 shows a perspective view of a pan held in place by a plurality of support forms disposed on a support base according to one embodiment of the disclosure;

FIG. 10 shows a side view of a pan held in place by a plurality of support forms disposed on a support base according to one embodiment of the disclosure;

FIG. 11 shows a perspective view of the relationship between a pan held in place by a plurality of support forms disposed on a support base according to one embodiment of the disclosure;

FIG. 12 shows a side view of the forces acting on a pan held in place by a plurality of support forms disposed on a support base according to one embodiment of the disclosure;

FIG. 13 shows a side view of a pan held in place by a plurality of support forms disposed on a support base according to one embodiment of the disclosure;

FIG. 14 shows a side view of a pan held in place by a plurality of support forms disposed on a support base according to one embodiment of the disclosure;

FIG. 15 shows a side view of a pan held in place by a plurality of support forms disposed on a support base according to one embodiment of the disclosure;

FIG. 16 shows a perspective view of lids held in place by a support form disposed on a support base according to one embodiment of the disclosure;

FIG. 17 shows a perspective view of pans and lids held in place by a plurality of support forms disposed on a support base according to one embodiment of the disclosure;

FIG. 18 shows an overhead view of pans and lids held in place by a plurality of support forms disposed on a support base according to one embodiment of the disclosure;

FIG. 19 shows a perspective view of a support base slidably disposed in a frame according to one embodiment of the disclosure;

FIG. 20 shows a side view of a track useful in accordance with one embodiment of this disclosure;

FIG. 21 shows an overhead view of a support base disposed in a frame and installed in a cabinet according to one embodiment of the disclosure;

FIG. 22a shows a perspective view of an assembled support base, track, and frame according to one embodiment of the disclosure in position for transportation;

FIG. 22b shows a side view of an assembled support base, track, and frame according to one embodiment of the disclosure in position for transportation; and

FIG. 23 shows a device according to one embodiment of the disclosure mounted in a cabinet beneath a kitchen countertop.

### DETAILED DESCRIPTION

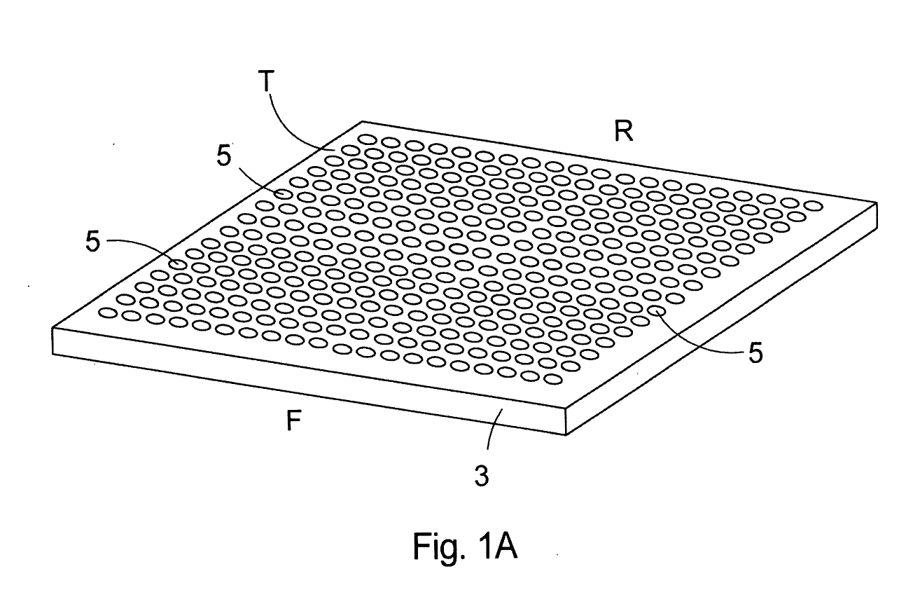

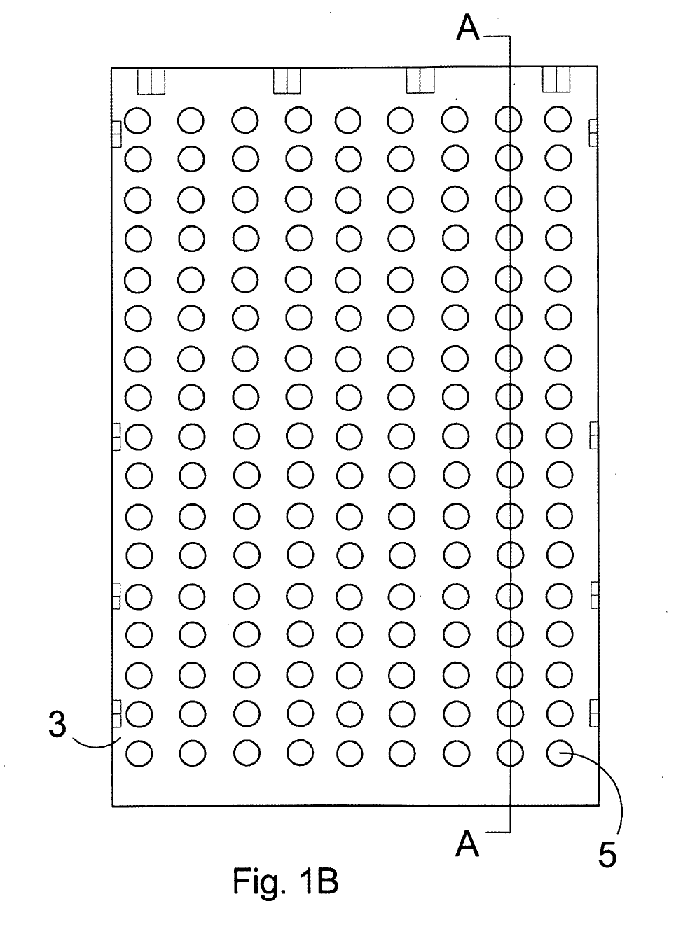

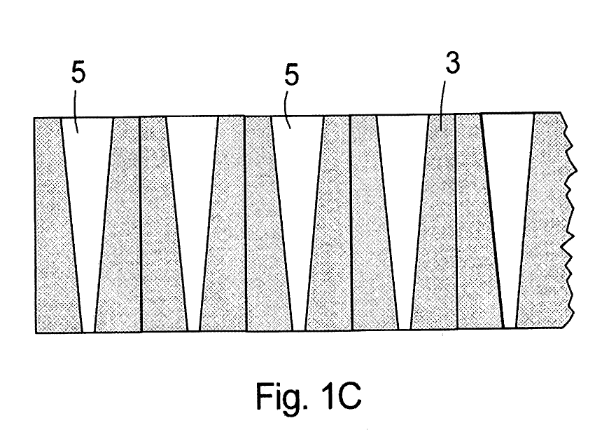

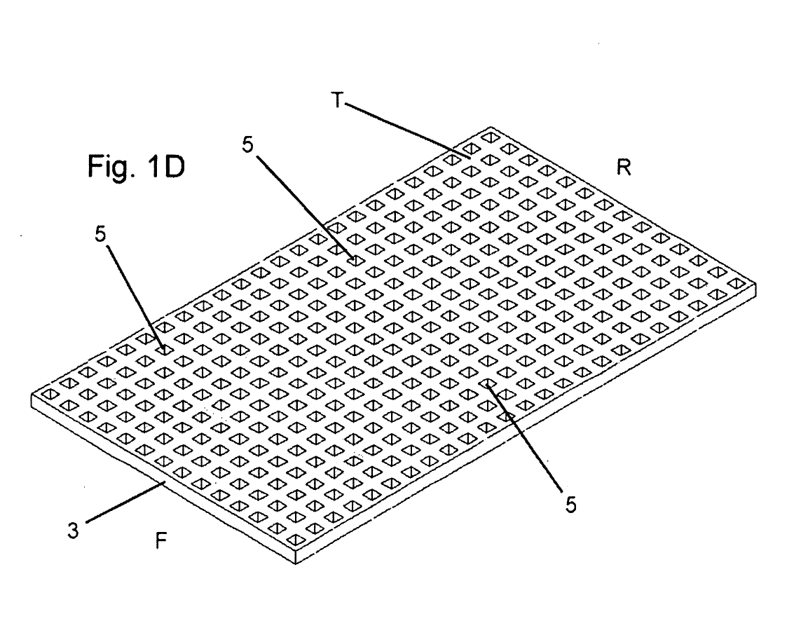

Referring to the drawings and initially to FIG. 1A there is shown a perspective view of a support base 3 according to one embodiment of the disclosure. In this embodiment, the support base 3 is comprised of a piece of stock which exists substantially in the form of a rectangular solid, and has a plurality of holes 5 disposed through its top surface portion T. However, a support base 3 may be shapes other than rectangular, including without limitation square, triangular, circular, oval, pentagonal, hexagonal, etc., and may be shaped as an irregular polygon. The stock from which a support base 3 (and other elements of a combination according to this disclosure) may be constructed or comprised may be any stable solid stock material, including without limitation: woods, metals, alloys of metals, polymers, including homopolymers and copolymers of alpha olefins, including polypropylene polymers and polyethylene polymers, vinyl acetate copolymers, ABS polymers, vinyl polymers such as PVC and CPVC, nylon polymers, PET polymers, polycarbonate polymers, or any other known polymeric material. The stock The stock from which a support base 3 may be constructed also includes composite materials, such as fiberglass reinforced resins, carbon fiber reinforced resins, reinforced polyamides, or any reinforced resin material. The holes 5 which are disposed through the top surface portion T of the support base 3 may terminate at any point within the body of the stock of the support portion 3 provided functionality as herein described is retained; however, in a preferred embodiment the holes 5 extend all the way through the bottom of the support portion 3. Although shown in FIG. 1A as being present as arranged in a rectangular array, a plurality of holes 5 may be disposed through the top surface portion T of the support base 3 in any array, including without limitation square, triangular, circular, oval, pentagonal, hexagonal, etc., and may be disposed thereon in the shape of any irregular polygon, linear or however a user of a combination according to this disclosure may desire.

The support base 3 has a front portion near the label F and a rear portion disposed towards the label R. Although the holes 5 are shown in this FIG. 1A as uniformly covering the top surface portion T of the support portion 3 in a rectangular array, it is within the scope of the present disclosure to employ any other geometric patterns of holes on the top surface T of the support portion which includes areas or regions where no holes 5 exist. Additionally, any number of holes 5 may be present. For example, as few as two such holes may be used and as many as up to about 1000 or more holes may be used. In addition, although preferable, the top surface T of the support portion need not be absolutely planar, but can include any degree of curvature (either convex or concave) on its topography, as viewed from a side perspective, and such curvature may be disposed randomly or in any order desired, as viewed from an overhead perspective.

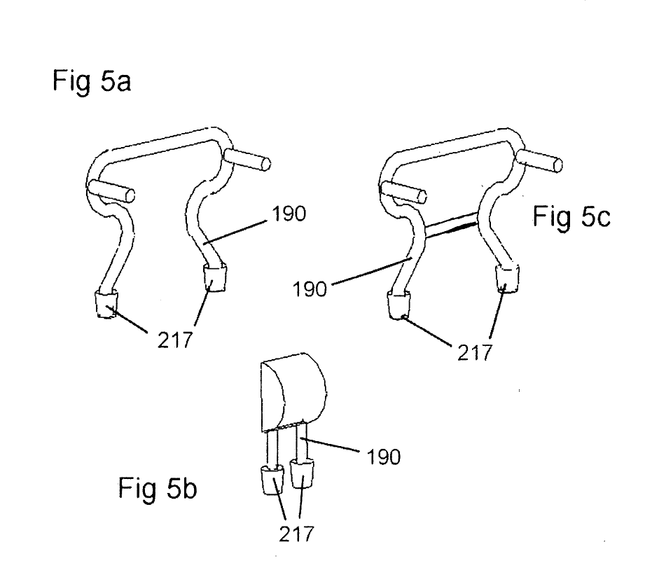

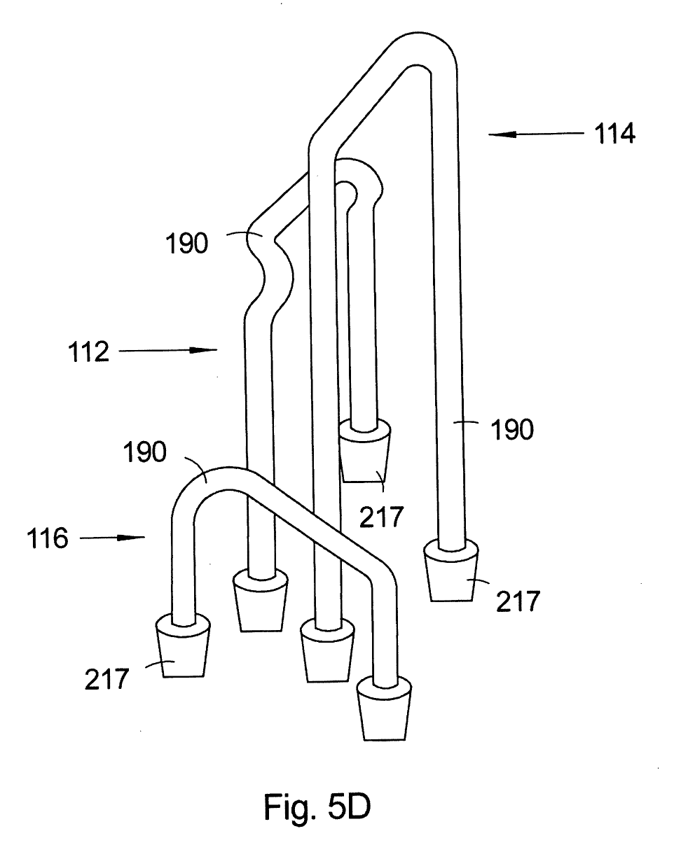

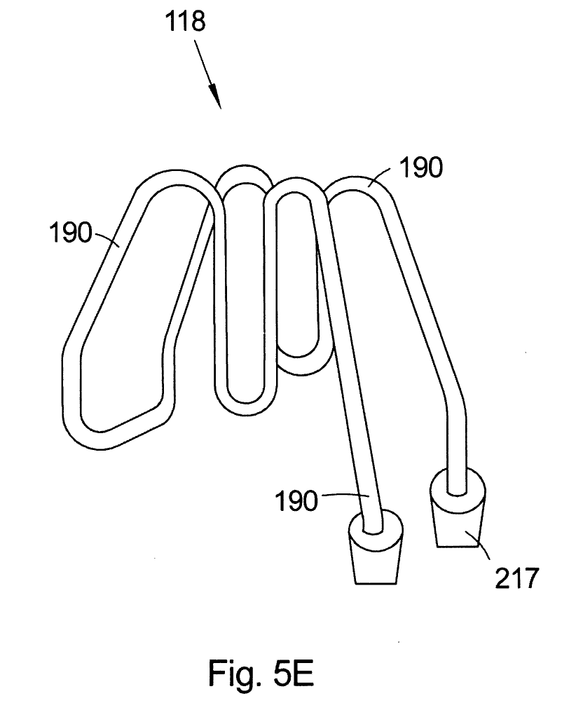

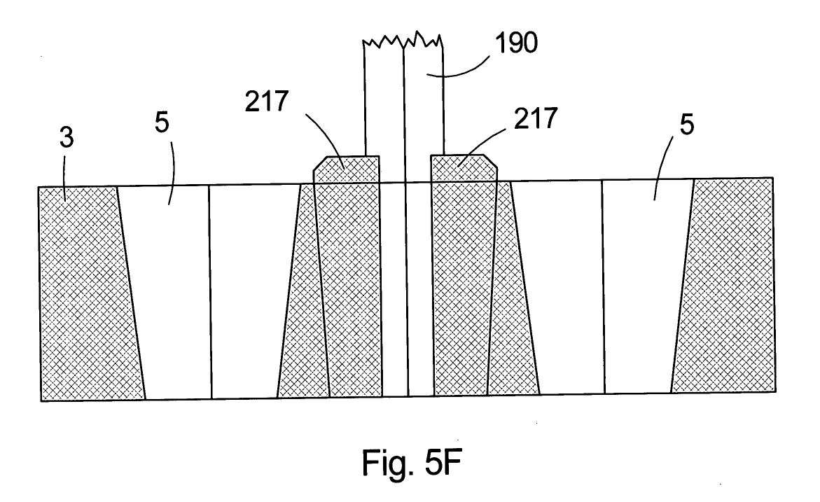

FIG. 1B shows an overhead view of a support portion 3 useful in providing a combination according to one embodiment of the disclosure, and indicates a sectional view A that is shown in more detail in the part sectional view shown in FIG. 1C that depicts the shape of the holes 5 useful in one embodiment relative to the body portion of the support base 3. As shown in FIG. 1D, the holes 5 need not necessarily be circular, as viewed from above, but may also be rectangular, or may have essentially any other contour, provided that the end portions 217 of the various support forms (FIGS. 5A, 5B, 5C, etc.) are contoured to be complementary to the location and shape of the holes 5 such that the end portions 217 are selectively engageable with the holes 5, as hereinafter described. Contours for the holes 5 and end portions 217 of the various support forms include, without limitation, circular, oval, rectangular, trigonal, pentagonal, hexagonal, star-shaped, etc.

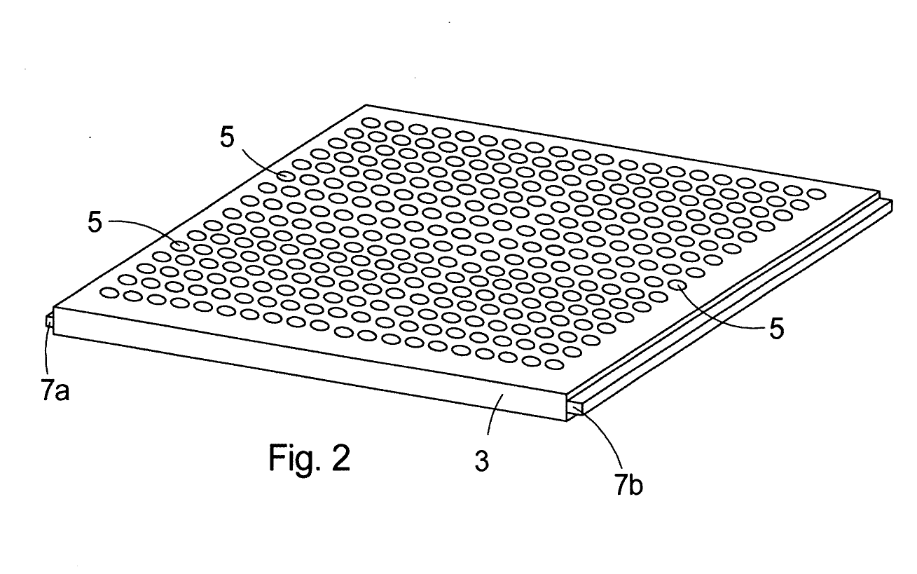

In FIG. 2 there is shown a perspective view of a support base 3 having features which confer the capability of slidably connecting the support base 3 to a frame, according to one embodiment of the disclosure. In this embodiment, this provision of features includes the linear tongues 7a and 7b, which are attached to the left and right sides of the support base 3 from which the support base is comprised. The linear tongue in one embodiment may include lip(s) made of metal, plastics, etc., having a lower surface, which lip(s) extend(s) substantially along the length of the side(s) of the support base 3. Such a feature is known among those skilled in the art of providing sliding drawers, as many drawers are made to be slidably disposed within a frame in which they reside by means of such lip(s) or tongues extending substantially along the lengths of their edges, wherein the lip(s) or tongues include a lower surface that rides on complementary rollers which are attached to the inside of the drawer mount or frame and are adapted to receive such lip(s) or tongues and provide them and the article to which they are attached, in this case the support base 3, with lateral movement capability, as means for providing such motion are known in the art.

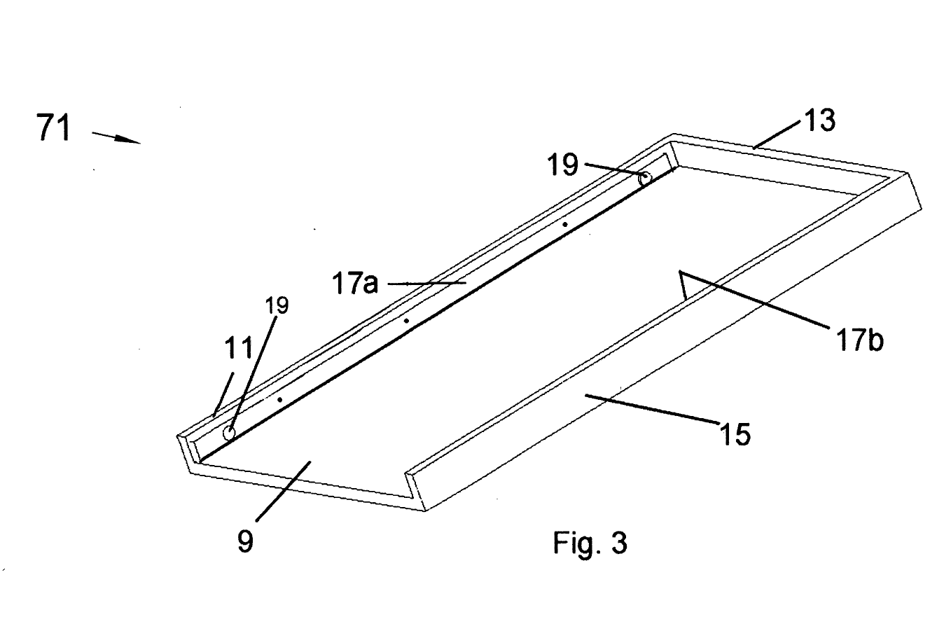

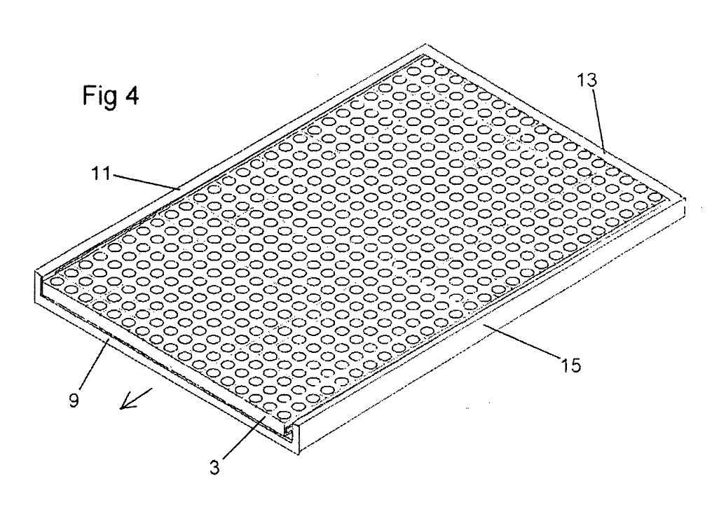

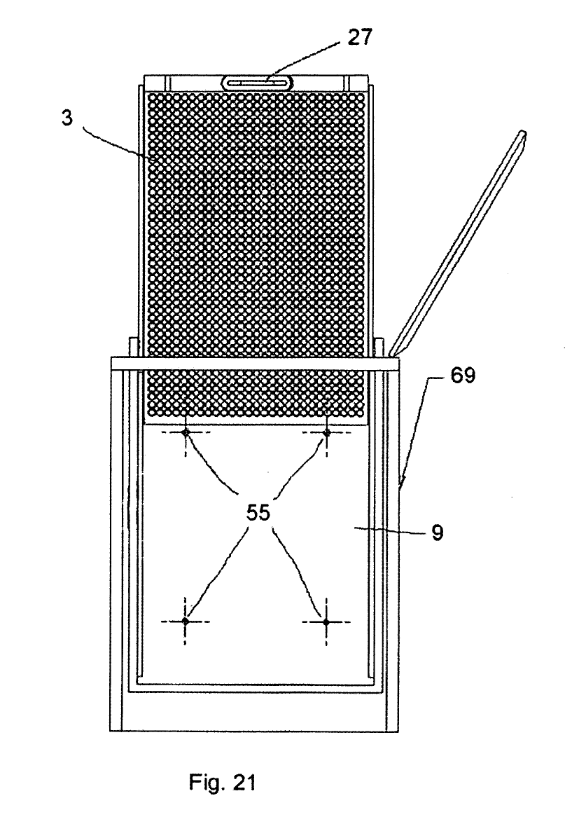

FIG. 3 shows a frame construct 71 having hardware attached thereto that is adapted to receive the support base 3 shown in FIG. 2 to this frame construct in a manner which enables the support base 3 to slide into and out of the frame construct 71, according to one embodiment. This frame construct 71 in this embodiment collectively comprises a left frame member 11, a rear frame member 13, and a right frame member 15. These frame members are connectively attached to one another using conventional means such as nails, screws, adhesives, welds, etc., to provide the arrangement shown, which provides useful locations for the mounting of tongue-receiving hardware 17a and 17b that are adapted to receive the linear tongues 7a and 7b in a manner which enables the support base 3 to which they are attached to be slidably mounted within the frame construct 71. Although not visible from this perspective, tongue-receiving hardware 17b is a substantial mirror image of that of 17a with regards to its features and ability to slidably receive a linear tongue that is disposed on the side of a support base 3 as provided herein. The tongue-receiving hardware include rollers 19, which are positioned on both tongue-receiving hardware 17a and 17b. The frame construct is preferably dimensioned so that the distance between the rollers 19 on the tongue-receiving hardware 17a and 17b coincides substantially with the distance between the lower surfaces of the linear tongue 7a and 7b (FIG. 2) that are intended to reside upon the rollers 19, to enable the linear tongue 7a and 7b to ride on the rollers 19 disposed on the tongue-receiving hardware 17a and 17b, which, according to one embodiment, enables the support base 3 to move laterally with respect to the frame construct, in a direction shown by the arrow in FIG. 4. The frame construct 71 may optionally include a floor portion 9 (which may be comprised, without limitation, of any of the materials previously set forth herein), which can serve as a base to which frame members 11, 13, and 15 are connectively attached, by conventional means, to provide robust stability to the frame construct 71 as a whole. In one embodiment, the tongue-receiving hardware 17a and 17b are attached to the frame members 11 and 15, respectively, using conventional fastening means known to those skilled in the art. When present, a floor portion 9 may be provided with mounting holes 55 disposed through its surface (FIG. 21), which mounting holes 55 enable a combination according to this disclosure to be conveniently mounted to the floor of an existing cabinet, or elsewhere. In addition, for added structural strength, the individual frame members 11, 13, 15 may be connected to one another as shown using conventional fastening means, including adhesives, tongues and grooves, dovetail joints, etc.

FIG. 4 shows a planar support base 3 in one of its possible positions when attached to a frame construct 71 according to one embodiment of the disclosure. The arrow depicts the possible direction of lateral movement of the support base 3 with respect to the frame construct 71 to which it is attached, via its linear tongue 7a and 7b (FIG. 2) being in slidable contact with the tongue-receiving hardware 17a and 17b (FIG. 3).

In FIGS. 5A, 5B, and 5C there are shown various configurations of support forms according to different embodiments of the disclosure. These support forms each comprise a retaining portion 190 and end portions 217. The end portions 217 are preferably comprised of a non-rigid material, such as a thermoplastic elastomer, a thermoplastic vulcanizates, a vulcanized rubber, plastics, any polymer mentioned herein, cork, wood, etc.; however, the end portions 217 may also be comprised of rigid materials, such as a metal, metallic alloy, or composites. FIG. 5D shows configurations of support forms according to different embodiments of the disclosure, with each of the support forms 112, 114, 116 comprising end portions 217 and retaining portions 190. FIG. 5E shows a configuration of a support form 118 according to another embodiment of the disclosure. The retaining portions 190 of the support forms in one embodiment comprise malleable material, such as metallic wires which are coated with a protective polymeric substance, such as a polymeric coating, including without limitation any of the polymeric materials mentioned elsewhere herein. The wires which comprise retaining portions 190, when the retaining portions are selected to be wire-based, may be single strand, braided, or coiled, and may include segments of other wires attached to them, as shown by the non-limiting examples of FIG. 5B. In alternate embodiments, the retaining portions may be blocks, shapes, or forms of any material, as shown in FIG. 5B, and may comprise any solid shape or form desired, provided they are provided with end portions 217 which can be engaged with holes 5 in the support base 3.

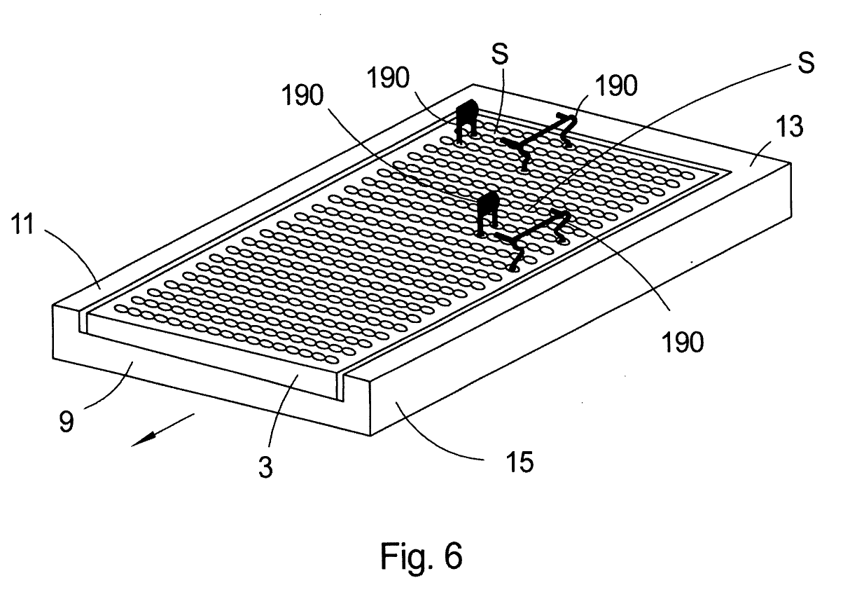

In FIG. 5F is shown a section view of the end portion 217 of a support form in place in the hole 5 of a support base 3 according to one embodiment of the disclosure. Thus, the end portions 217 are preferably contoured so that they fit securely, but removably, within the holes 5 disposed on the top surface T of the support base 3. This enables the support forms each as a whole to be readily affixed to locations above, at, or near the top surface T of the support base 3, as shown in FIG. 6, by placing, inserting, or lodging the end portions 217 into the holes 5. Thus, it is preferred that the distance between the two end portions 217 corresponds substantially to the distance between a pair of holes 5 disposed on the top surface of the support base 3. In one embodiment, the retaining portions 190 are preferably comprised of a rigid material, such as a hard polymer, metal, or metal alloy. In a preferred embodiment the retaining portions 190 are comprised of heavy wire, having any cross-sectional diameter in the range of between about 1 millimeter or less to about 25 millimeters or more, with a diameter of about 6-12 mm being especially preferred. In one embodiment the wire is rigid and non-bendable. In another embodiment, the wire is flexible, which permits the user to bend the retaining portion 190 into any shape as the user deems fit. Thus, the shape of the retaining portion 190 may be any shape, form, or contour desired by the user, and may comprise any bend or configuration desired. A combination according to the disclosure may employ the use of either or both, support forms having rigid or non-rigid retaining portions 190.

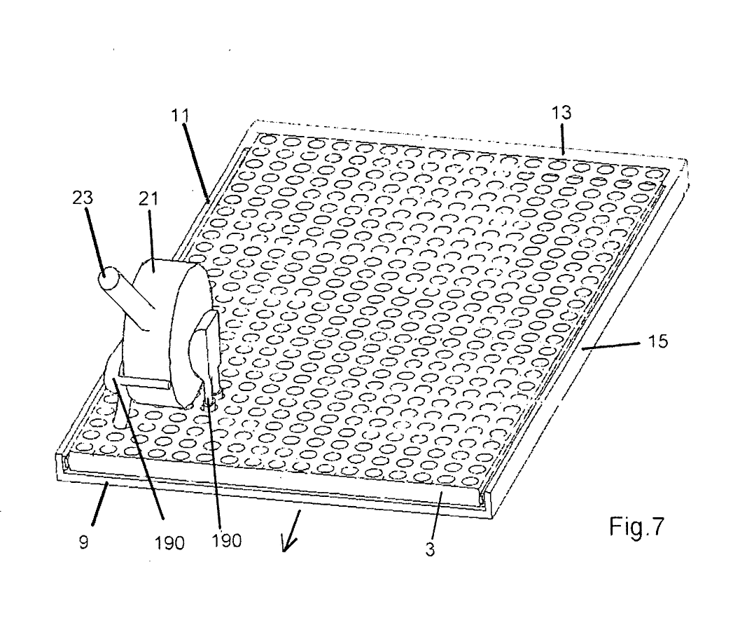

Thus FIG. 6 shows a planar support base 3 in one of its possible positions when attached to a frame construct 71 according to one embodiment of the disclosure, further including a plurality of support forms having retaining portions 190 (FIGS. 5a, 5b, 5c) attached to the support base 3. Also shown are the respective locations of the floor portion 9 when selected to be present, the left frame member 11, rear frame member 13, right frame member 15, support base 3, and the plurality of support forms having retaining portions 190 held in place by the end portions 217 (FIG. 5F) being disposed within various holes 5 on the support base 3. By judicious selection of the positions at which the retaining portion 190 are disposed, it is possible to create and define spaces S between the retaining portion 190. These spaces S are suitable locations at which appropriately contoured wares and utensils may be held in a retained position between the different retaining portions 190, such as the pan 21 shown in FIG. 7. This arrangement enables the handle portion 23 of the pan to be disposed in an upward position, or any other desired position, to make efficient storage use of the surface area of the support base 3 while simultaneously enabling the pan to be readily grasped.

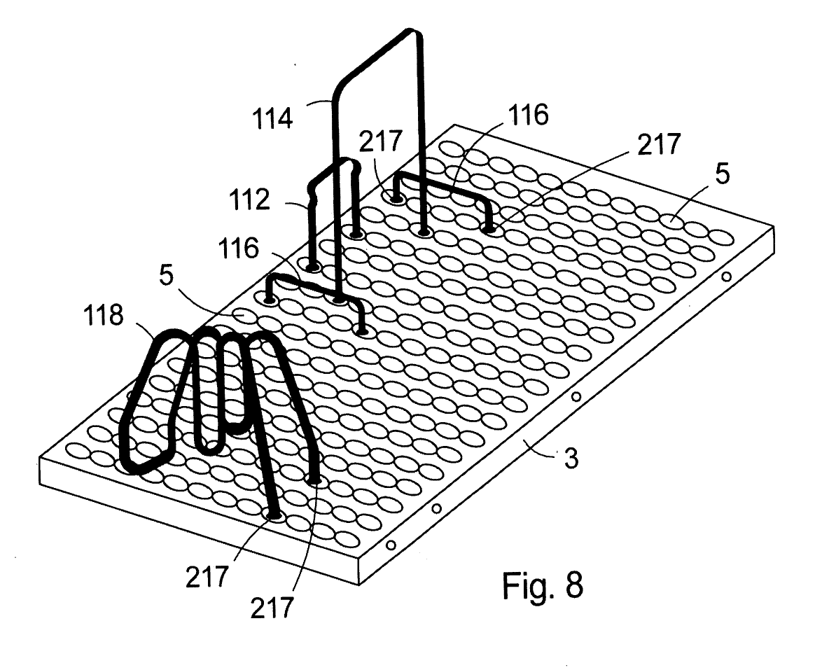

In FIG. 8 is shown a perspective view of a plurality of support forms disposed on a support base 3 according to one embodiment made possible by this disclosure. In FIG. 8, support form 112, support form 114, support forms 116, and support form 118 are attached to the support base by their end portions 217 (not labeled) being disposed in the holes 5 on the top surface of the support base 3.

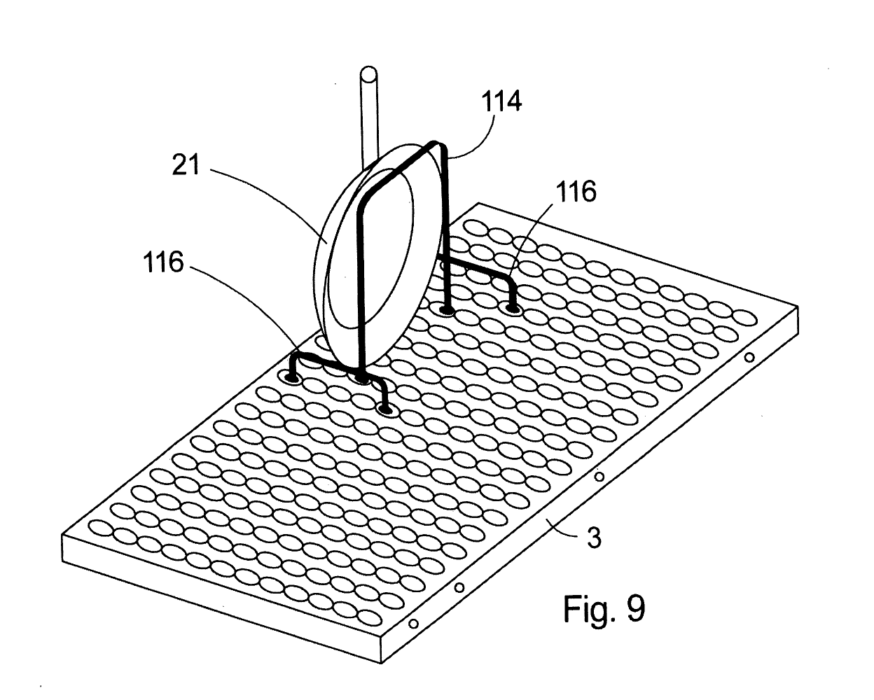

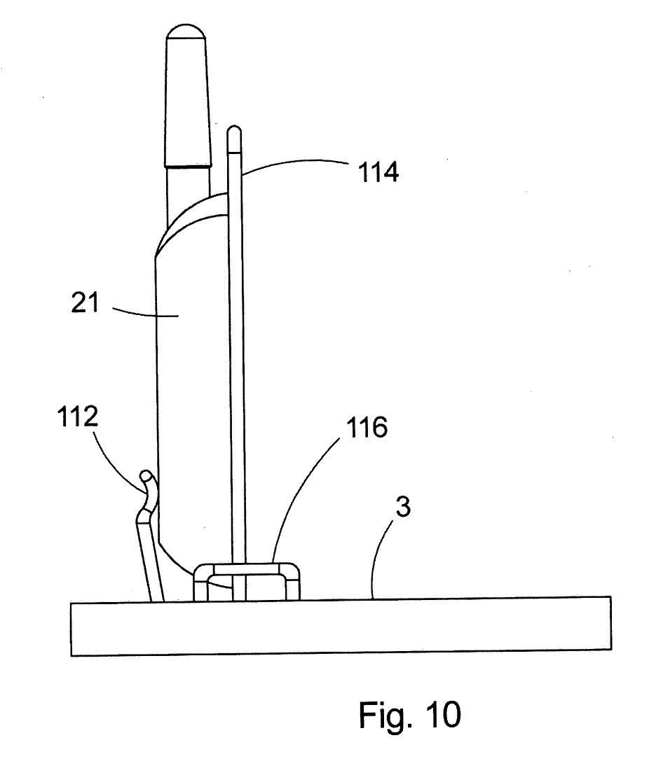

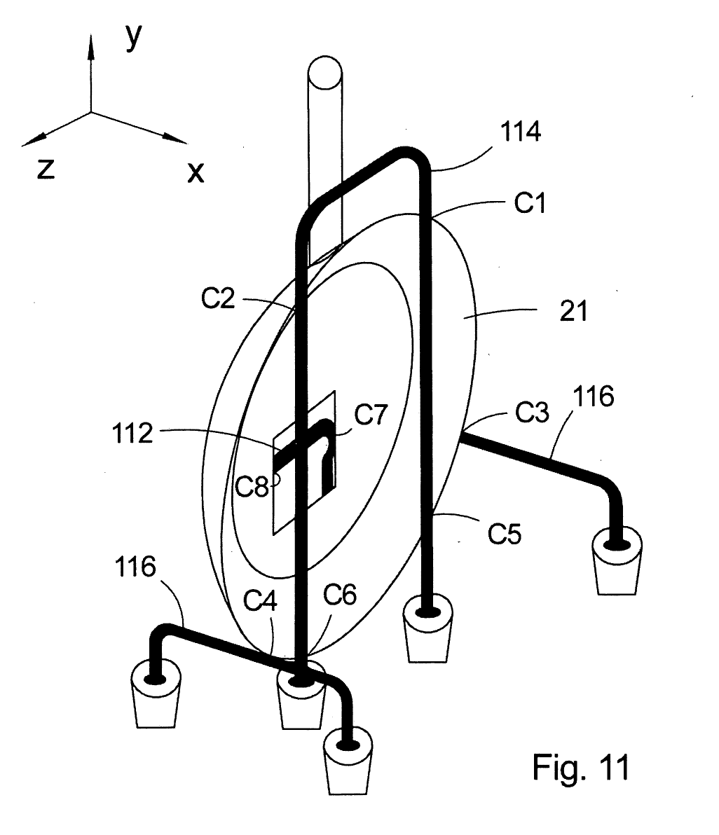

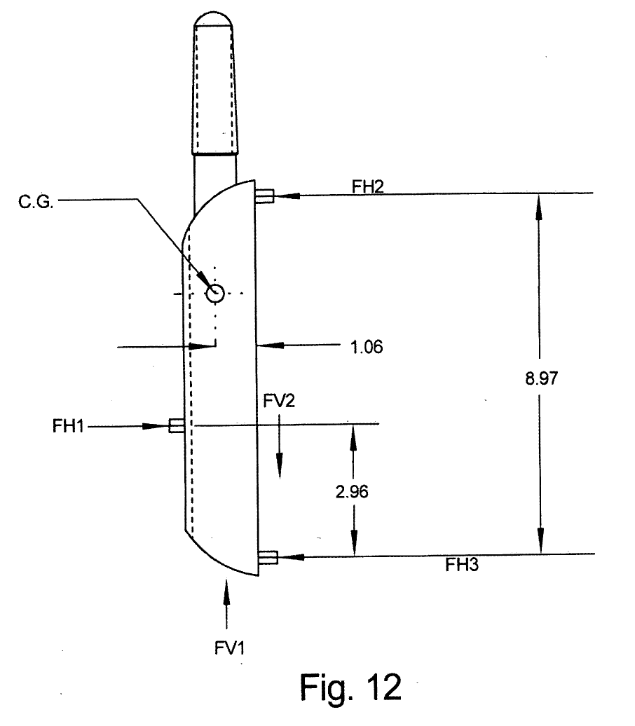

In FIG. 9 is shown a perspective view of a pan 21 held in place by a plurality of support forms disposed on a support base 3 according to one embodiment of the disclosure. The pan may be of any size, including without limitation, for example, a pan that is 10 inches in diameter. In this view, the support form 112 from FIG. 8 is present, but not visible from this perspective. The support form 112 holds the pan rigidly in position. However, FIG. 10 shows a side view of the pan 21 held in place by the same plurality of support forms of FIG. 9 disposed on a support base 3. FIG. 11 shows a perspective view of the relationship between the pan 21 held in place by the plurality of support forms disposed on a support base 3 according to FIGS. 9 and 10. The x, y, z coordinate axes are helpful in understanding the forces acting on the pan 21, which are discussed in reference to FIG. 12. In FIG. 11, are shown the various points of contact between the pan 21 and the support forms 112, 114, and 116. Support form 112 contacts the bottom of the pan 21 at contact surfaces c7 and c8. Support form 114 contacts the top of the pan at contact surfaces c1, c2, c5, and c6. Support forms 116 contact the edges of pan 21 at contact surfaces c3 and c4. The location retention of the pan 21 relative to the support base 3 is generated by support form 112 pushing the bottom of pan 21 while support form 114 contacts the top of the pan and resists the force of the support form 114, thus trapping pan 21 along the x-axis. Support forms 116 provide a vertical support location (y-axis) for pan 21. Because of the location of support forms 116, there is also retention of pan 21 along the z-axis.

In FIG. 12 provides a side view of pan 21, with an indication of the forces acting on pan 21. The designation “C.G.” represents the location of the center of gravity of the pan. FH1 indicates the force applied by support form 112 at the bottom of pan 21. FH2 indicates the force applied to the top of pan 21 by support form 112. FH3 indicates the force applied by support form 114 at the bottom location of the top surface of pan 21. FV1 indicates the y-component of the force applied by support form 116. FV2 indicates the force due to the weight of pan 21. The relationships between these forces as the force FH2 is varied from 0 to 2.5 pounds using a pan 21 having a weight of 4 pounds can be calculated from the formula:

FH1i=[(C.G.*1.06)+(FH2i*8.97)]/2.96

wherein “*” indicates multiplication, (i) is an indexing tool to increment the value of FH2i, viz., i=0,1, . . . 10. FH2i=0+0.25*I, and FH3i=FH1i−FH2i.

TABLE I
FH2 values

| | i | | | | | | | | | | |
|---|---|---|---|---|---|---|---|---|---|---|---|
| | 0 | 1 | 2 | 3 | 4 | 5 | 6 | 7 | 8 | 9 | 10 |
| F | 0 | 0.25 | 0.5 | 0.75 | 1 | 1.25 | 1.5 | 1.75 | 2 | 2.25 | 2.5 |

TABLE II
values of FH3 as FH2 is varied from 0 to 2.5 pounds

| | i | | | | | | | | | | |
|---|---|---|---|---|---|---|---|---|---|---|---|
| | 0 | 1 | 2 | 3 | 4 | 5 | 6 | 7 | 8 | 9 | 10 |
| F | 1.432 | 1.94 | 2.448 | 2.955 | 3.463 | 3.97 | 4.478 | 4.986 | 5.493 | 6.001 | 6.508 |

TABLE III
values of FH1, as FH2 is varied from 0 to 2.5 pounds

| | i | | | | | | | | | | |
|---|---|---|---|---|---|---|---|---|---|---|---|
| | 0 | 1 | 2 | 3 | 4 | 5 | 6 | 7 | 8 | 9 | 10 |
| F | 1.432 | 2.19 | 2.948 | 3.705 | 4.463 | 5.22 | 5.978 | 6.736 | 7.493 | 8.251 | 9.008 |

Similar calculations may be carried out for pans and other utensils having a weight that is different than four pounds, using any desired increment i. From the foregoing, it is seen that when FH2 is 0, then FH1 equals FH2, or 1.432 pounds. The clamping force on pan 21 is the sum of FH1, FH2, FH3 or 2.464 pounds. If FH2 is one pound, then FH1 equals 4.463 pounds and FH3 equals 3.463 pounds, with the total clamping force on pan 21 being 8.296 pounds. The clamping force between the support forms and pan 21 provides additional retention of pan 21 due to the friction of the contacting surfaces and the applied forces. In order to develop a clamping force, a user can position support form 112, and/or support form 114 in any fashion desired. Thus, by the present disclosure, by appropriate selection of materials for the support forms' retaining portions 190, end portions 217 and support base 3, any degree of horizontal clamping force (horizontal, with respect to the surface T of the support base 3) between about 0.1 pounds to about 20 pounds may be provided to a ware, utensil or object that is disposed in a space S between a plurality of support forms, including all ranges of forces between 0.1 pounds and 20 pounds.

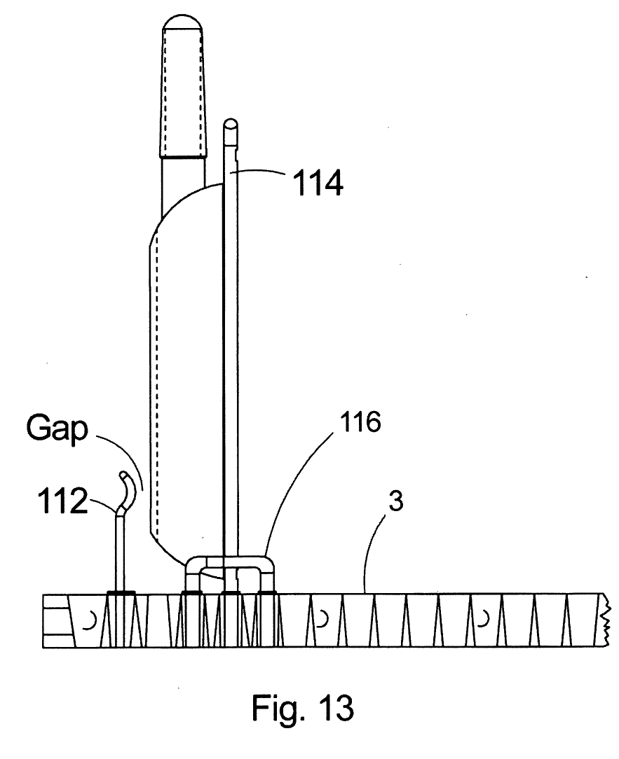

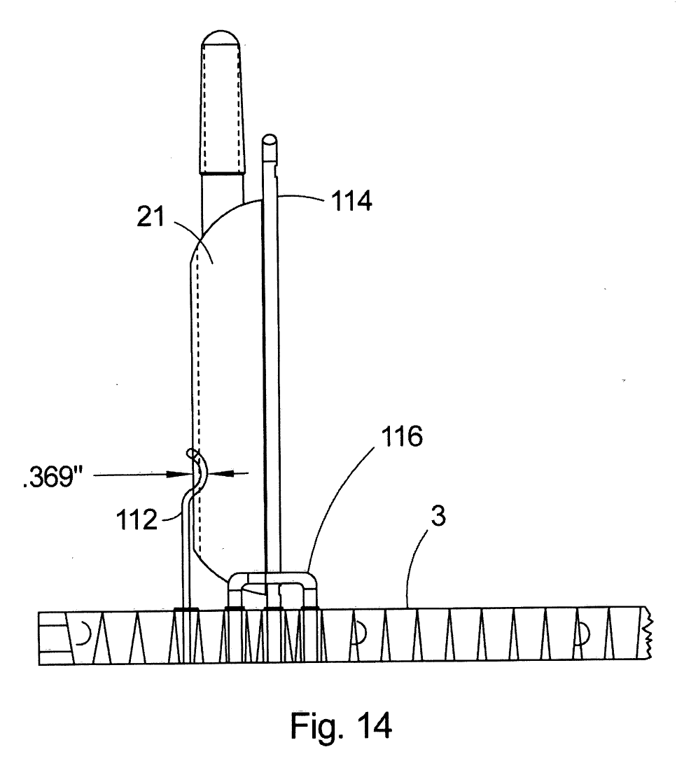

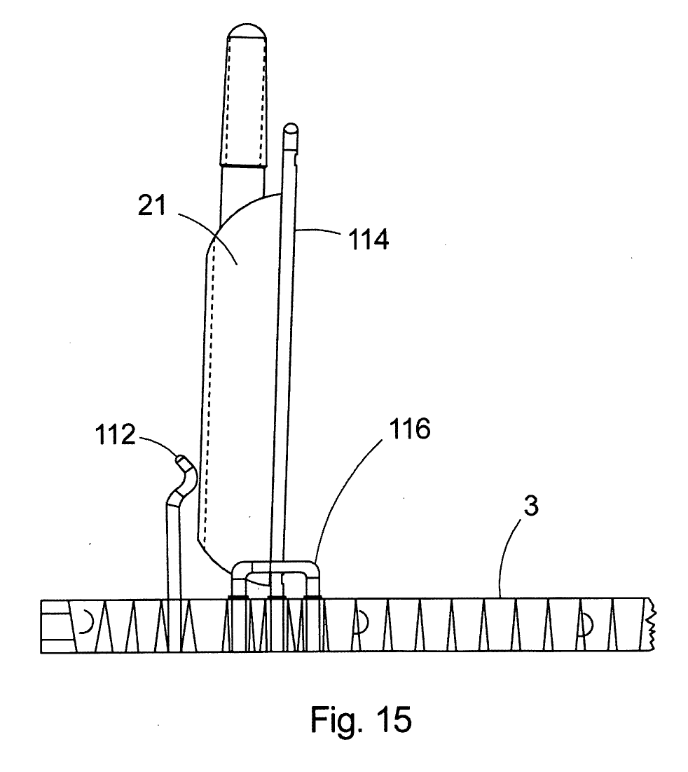

FIG. 13 shows a side view of a pan held in place by a plurality of support forms disposed on a support base 3 according to one embodiment of the disclosure. FIG. 13 depicts an instance in which support form 112 does not contact the bottom of pan 21. FIG. 14 shows this same pan, but where the support form 112 has been moved one grid space to the right, resulting in an interference condition of 0.369 inches of support form 112 to the bottom of pan 21. FIG. 15 shows the positions of support forms 112 and 114 that results when pan 21 is positioned with the support form 112 having an interference condition of 0.369 inches as shown in FIG. 14. This causes a deflection of position of the support forms 112 and 114. Applying a horizontal force of 3.7 pounds to the support form 112 in FIG. 15 results in a force of 0.7 pounds being provided to pan 21 at points c1, c2 (FIG. 11) and a force of 3 pounds being provided to pan 21 at points c5, c6 (FIG. 11). Based on Finite Element Analysis, support form 112 deflects 0.127 inches at its point of contact with the bottom of pan 21, and support form 114 deflects 0.231 inches at the upper contact location to pan 21. The total clamping force of support forms 112, 114 in such instance is 7.4 pounds.

The range of deflections of the support forms can be easily controlled by selection of the material properties of the end portions 217 of the support forms (of which 112, 114, 116, 118 are non-limiting examples) and the material and shape of the retaining portions 190, which may often be wires having a polymeric coating disposed thereon. A wide range of elastomers are available in the marketplace which are suitable for such “end” use, and a particular selection of a material depends on the immediate needs of the user, which is readily determined. Thus, this disclosure provides arrangements that allow deflection of the support forms and the ability to position the support forms relative to a pot or pan to develop a clamping force which prevents the pot or pan from moving to any appreciable extent along the direction of the clamping force. In one embodiment, the end portions 217 of the support forms are akin to common tapered cylindrical rubber stoppers employed by chemists for stoppering the necks of flasks, and the ends of the retaining portions 190 comprise wire which is disposed through the body of such rubber stoppers.

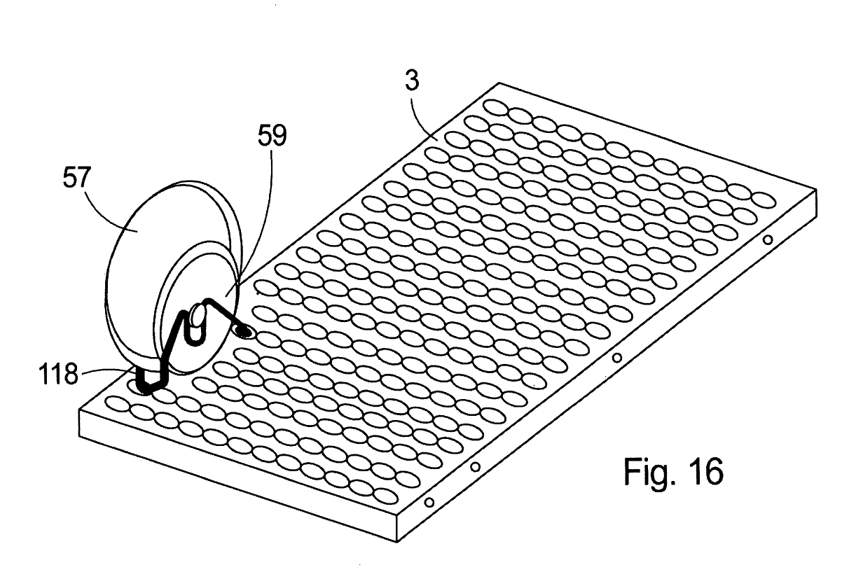

FIG. 16 shows a perspective view of lids held in place by support form 118 disposed on a support base 3 according to one embodiment of the disclosure. Support form 118 can hold two lids and is contoured to accommodate a large lid 57 and a small lid 59. Support form 118 can be located at many possible locations on the support base 3, which allows the users to customize arrangements to their own personal tastes.

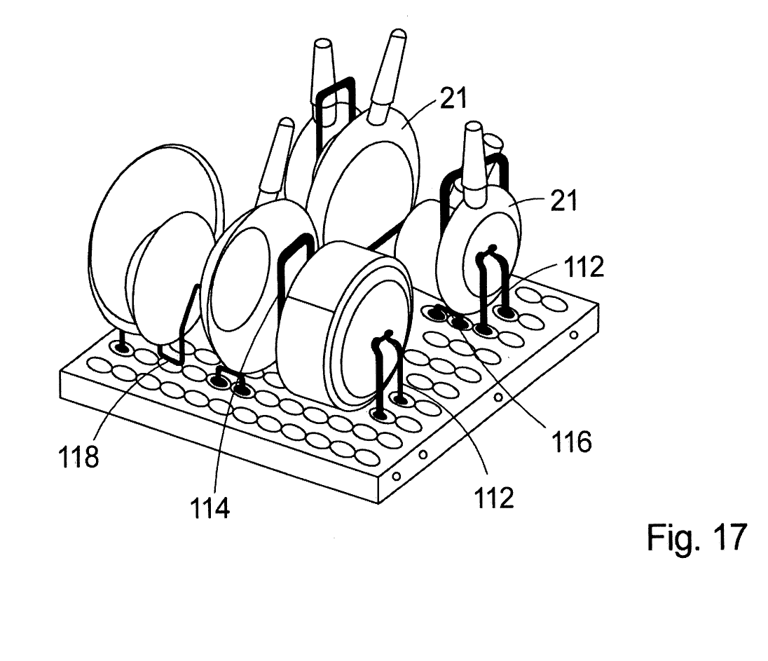

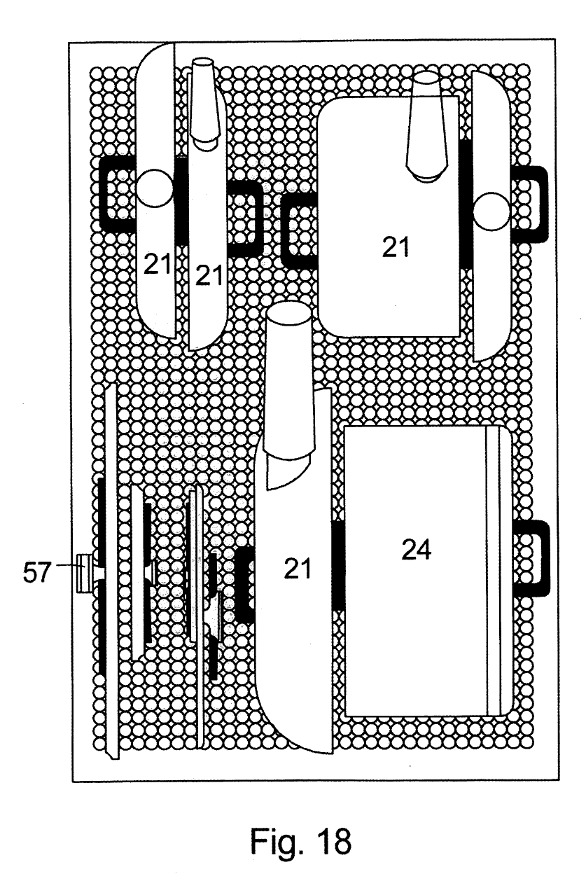

FIG. 17 shows a perspective view and FIG. 18 shows an overhead view of pans and lids held in place by a plurality of support forms disposed on a support base 3 according to one embodiment of the disclosure.

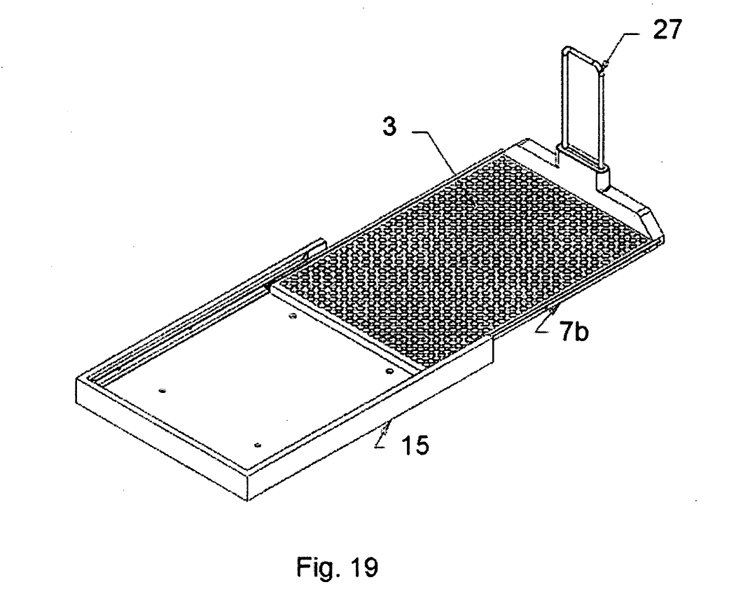

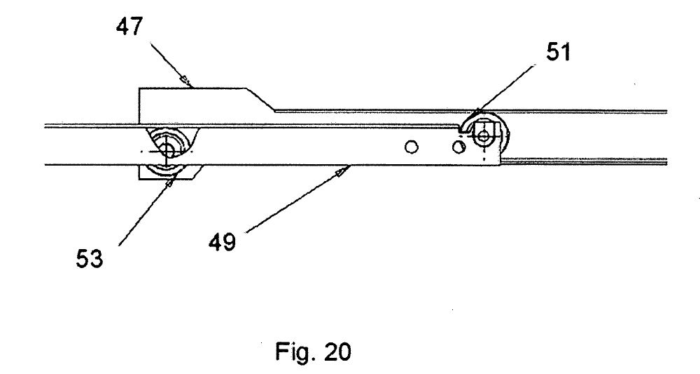

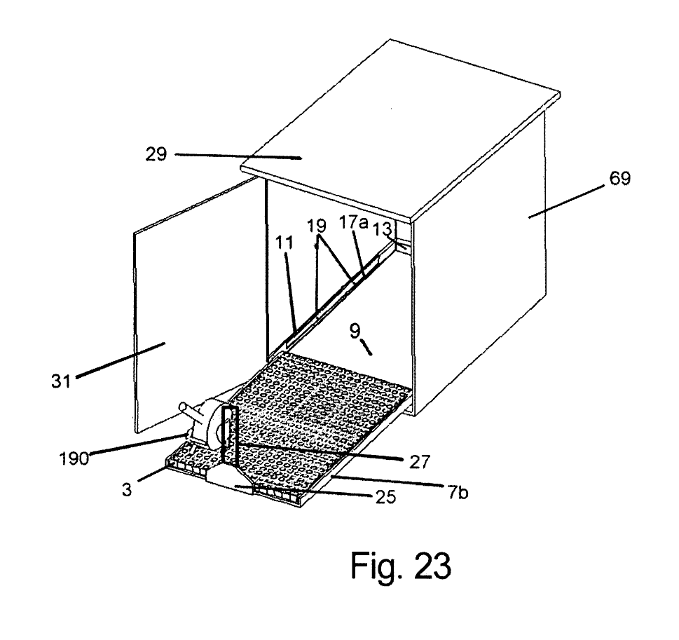

In FIG. 19 is shown a perspective view of a support base 3 slidably disposed in a frame construct 71 according to one embodiment of the disclosure. Here, the handle 27 is shown attached to a frontal flange 25 (FIG. 23). A track useful in accordance with one embodiment of the disclosure is shown in FIG. 20 having a fixed rail 47, a translating rail 49, a first roller 51 and a second roller 53. In practice, the fixed rail 47 is mounted to a frame member 13, 15 and the translating rail is mounted to a side of the support base 3. This type of track is well-known in the drawer and cabinet arts. However, any means known in the art for providing a sliding assembly as described herein is suitably employable. While reference has been made herein to a frame construct 71, and such frame constructs may be provided to have essentially any rectangular dimensions, the present disclosure also provides where the walls of an existing cabinet may function as right, left, and rear frame members, with one portion of the complimentary tracks or slides being disposed on the walls of such existing cabinet, with the remaining complimentary portion of the tracks or slides being disposed on the side portions of the support base 3. Accordingly, the dimensions of a support base 3 may be selected to accommodate its employment within any existing cabinet. In one embodiment, a complimentary portion of a slidable track is attached to the side portions of the support base 3 by means of screws disposed in holes in the side(s) of the support base 3. The present disclosure also provides support forms having but a single end portion 217.

FIG. 21 shows an overhead view of a support base 3 disposed in a frame construct and installed in a cabinet 69 according to one embodiment of the disclosure. In this embodiment, there are four mounting holes 55 through which a user may drive conventional fasteners, which may include self-tapping wood screws, to firmly attach a combination according to the disclosure to the floor of the cabinet 69.

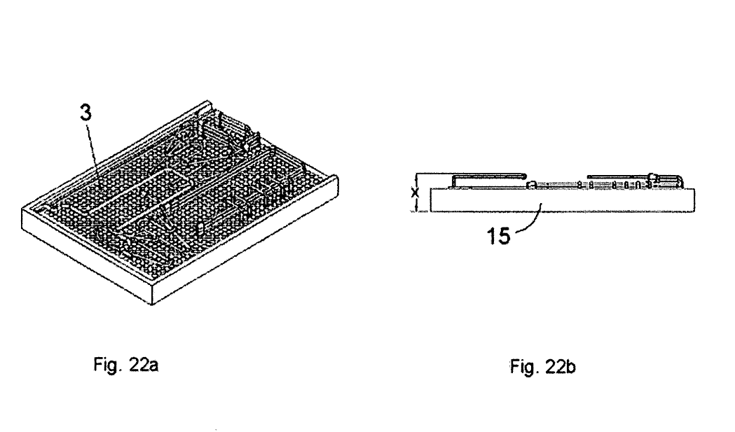

FIG. 22a shows a perspective view of, and FIG. 22b shows a side view of an assembled support base, track, and frame combination according to one embodiment of the disclosure, in position for transportation.

In FIG. 23 is shown a combination according to one embodiment of the disclosure in its final in-use arrangement, mounted in a cabinet 69 beneath a kitchen countertop 29. In FIG. 23 are shown the respective locations of the elements of the floor portion 9, the left frame member 11, rear frame member 13, support base 3, linear tongue 7b, tongue-receiving hardware 17a, retaining portion 190 held in place by the end portions 217 disposed in various holes 5 on the support base 3, and rollers 19. In one embodiment, there is a frontal flange 25 attached to the front portion of the support base 3 by conventional means. In one preferred embodiment, there is a handle 27 attached to this flange, which allows a user to pull the slidably-mounted support base 3 out of the cabinet, to gain easy access to wares and utensils disposed on the support base 3, held rigidly in place by the plurality of retaining portions 190. The flange 25 may be a sheet of material such as plywood, polypropylene, a metallic alloy, etc. which is conventionally fastened to the front portion of the support base 3 or which may be of singular construction therewith, such as in the case when the support base 3 and flange 25 both comprise a single injection-molded article comprised of a polymer.

The handle 27 may be grasped and pushed, so that the support base 3 is pushed back into the cabinet, and the cabinet door 31 may be closed. In an alternate embodiment, no floor portion 9 is used as a member of the frame; rather, the bottom of the cabinet serves as the floor portion 9, and the tongue-receiving hardware 17a and 17b are themselves attached directly to the right and left walls of an existing cabinet 69.

Consideration must be given to the fact that although this disclosure describes and discloses in relation to certain preferred embodiments, obvious equivalent modifications and alterations thereof will become apparent to one of ordinary skill in this art upon reading and understanding this specification and the claims appended hereto. This includes subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claim(s) so modified. This also includes combination of the features and/or limitations of one or more of the independent claims with features and/or limitations of other independent claims to arrive at a modified independent claim, with the remaining dependent claims in their original text being read and applied to any independent claim so modified. Accordingly, the present disclosure is intended to cover all such modifications and alterations, and is limited only by the scope of the claims which follow, and the disclosure herein.

What is claimed is:

1) A combination useful for the convenient storage and retrieval of various wares and utensils, which comprises:
a) a support base having a top surface, said top surface including a plurality of holes disposed therethrough;
b) a frame construct;
c) means for slidably attaching said support base to said frame construct sufficiently to enable lateral movement of said support base with respect to said frame construct; and
d) at least one support form disposed on the top surface of said support base, said support form(s) each comprising a retaining portion and at least one end portion, wherein said holes disposed on said surface of support portion are adapted to receive said at least one end portion of said at least one support form.

2) A combination according to claim 1 wherein said retaining portion is flexible.

3) A combination according to claim 1 wherein said retaining portion is rigid.

4) A combination according to claim wherein said plurality of holes are arranged to comprise a rectangular pattern.

5) A combination according to claim 1 wherein said holes are shaped in a shape selected from the group consisting of: rectangular holes, circular holes, oval holes, triangular holes, pentagonal holes, and hexagonal holes.

6) A combination according to claim 1 wherein said holes pass completely through said support base.

7) A combination according to claim 1 wherein said holes pass partially through said support base.

8) A combination according to claim 1, and further comprising: e) a cabinet having an interior, wherein said frame construct is disposed within the interior of said cabinet.

9) A combination according to claim 1 wherein the frame construct includes a floor portion.

10) A combination according to claim 1 wherein the top surface of the support base is substantially-planar.

11) A combination according to claim 1 further comprising: e) a handle attached to said support base.

12) A combination according to claim 1 wherein two of said plurality of support forms attached to the top surface of said support base are arranged so as to define a space between them, which space is sufficient to contain and sustain a cooking utensil in a fixed position.

13) A combination according to claim 1 wherein two of said at least one support forms attached to the top surface of said support base are arranged so as to define a space between them, which space is sufficient to contain and sustain a utensil in a fixed position.

14) A combination according to claim 13 wherein said plurality of support forms provide any degree of horizontal clamping force between about 0.1 pounds to about 20 pounds to a utensil disposed in a space between said plurality of support forms.

15) A combination according to claim 14 wherein said plurality of support forms provide any degree of horizontal clamping force between about 0.5 pounds to about 5 pounds to a utensil disposed in a space between said plurality of support forms.

16) A combination useful for the convenient storage and retrieval of various wares and utensils, which comprises:
a) a frame construct, comprising a first half of a complimentary sliding track combination;
b) a support base connected to said frame construct, said support base having:
i) a top surface, said top surface including a plurality of holes disposed therethrough;
ii) a second half of a complimentary sliding track combination that is complementary to said first half attached thereto, said second half of said sliding track combination cooperating with said first half to enable lateral movement of said support base with respect to said frame construct; and
c) at least one support form disposed on the top surface of said support base, said support form(s) each comprising a retaining portion and at least one end portion,
wherein said holes disposed on said surface of support portion are adapted to receive said at least one end portion of said at least one support form.

17) A combination according to claim 16 wherein said frame construct is disposed within a cabinet.

18) A combination according to claim 16 wherein said at least one support form comprises a wire having two end portions, said end portions being engageable with said holes on said top surface.

19) A combination useful for storing various articles, comprising a support base that is slidably attached to the inside of a cabinet, wherein said support base has a top surface that includes a plurality of holes disposed therethrough, said holes being adapted to receive and hold in place one or more support forms, said support forms being arranged to provide a space between them that provides a horizontal clamping force on a utensil that is disposed within said space.

20) A combination according to claim 19 wherein said plurality of support forms provide any degree of horizontal clamping force between about 0.1 pounds to about 20 pounds to an article disposed in a space between said plurality of support forms.
